(19) United States
(12) Patent Application Publication
(10) Pub. No.: US 2015/0019584 A1
(43) Pub. Date: Jan. 15, 2015

(54) SELF-LEARNING JAVA DATABASE CONNECTIVITY (JDBC) DRIVER

(71) Applicant: International Business Machines Corporation, Armonk, NY (US)

(72) Inventors: Douglas C. Berg, Rochester, MN (US); Kulvir S. Bhogal, Fort Worth, TX (US); Nitin Gaur, Round Rock, TX (US); Christopher D. Johnson, Rochester, MN (US); Brian K. Martin, Cary, NC (US)

(21) Appl. No.: 13/942,351

(22) Filed: Jul. 15, 2013

(51) Int. Cl. G06F 17/30

(52) U.S. Cl. CPC G06F 17/30424
USPC 707/769

(57) ABSTRACT

Various embodiments include solutions for querying desired data from a database without pulling supererogatory data. In one embodiment, a method includes: obtaining an initial database access query between an application and the database at a self-learning JDBC driver; monitoring subsequent database access queries between the application and the database over a period; and generating a modified database access query for querying the database from the self-learning JDBC driver, the modified database access query based upon the subsequent database access queries between the application and the database over the period.

### TECHNICAL FIELD

Aspects of the invention relate generally to database access. More particularly, various aspects of the invention relate to accessing data via one or more Java Database Connectivity (JDBC) drivers.

### BACKGROUND

Some data access programs inefficiently retrieve data. For example, some Java access programs utilize SELECT statements that grab all of the columns of data in a table, when only a small subset of that data is desired. The conventional solution to this problem has been to utilize a data access grid. In the case of a data access grid, a Java virtual machine (JVM) stores a subset of data in a grid after it is retrieved from a database. However, JVMs require external database access infrastructure to be effective, which can be costly and time consuming to implement. In addition, data access grids have a limited capacity.

### BRIEF SUMMARY

Solutions for querying desired data from a database without pulling supererogatory data are disclosed herein. In one embodiment, a method includes: obtaining an initial database access query between the application and the database at the self-learning JDBC driver; monitoring subsequent database access queries between the application and the database over a period; and generating a modified database access query for querying the database from the self-learning JDBC driver, the modified database access query based upon the subsequent database access queries between the application and the database over the period.

A first aspect includes a computer-implemented method of managing a Java Database Connectivity (JDBC) driver data query at a self-learning JDBC driver interposed between an application and a database, the method including: obtaining an initial database access query between the application and the database at the self-learning JDBC driver; monitoring subsequent database access queries between the application and the database over a period; and generating a modified database access query for querying the database from the self-learning JDBC driver, the modified database access query based upon the subsequent database access queries between the application and the database over the period.

A second aspect includes a system having: at least one computing device associated with a Java Database Connectivity (JDBC) driver interposed between an application and a database, the at least one computing device configured to manage a data query at the self-learning JDBC driver by performing actions including: obtaining an initial database access query between the application and the database at the self-learning JDBC driver; monitoring subsequent database access queries between the application and the database over a period; and generating a modified database access query for querying the database from the self-learning JDBC driver, the modified database access query based upon the subsequent database access queries between the application and the database over the period.

A third aspect includes a computer program comprising program code embodied in at least one computer-readable storage medium, which when executed, enables a computer system interposed between an application and a database to manage a Java Database Connectivity (JDBC) driver data query by performing actions including: obtaining an initial database access query between the application and the database at the self-learning JDBC driver; monitoring subsequent database access queries between the application and the database over a period; and generating a modified database access query for querying the database from the self-learning JDBC driver, the modified database access query based upon the subsequent database access queries between the application and the database over the period.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an overview diagram according to embodiments.

FIG. 2 shows a schematic data/process flow diagram according to embodiments.

FIG. 3 (spanning pages 3 and 4) shows a flow diagram illustrating a method according to various embodiments.

FIG. 4 shows a schematic data/process flow diagram according to embodiments.

FIG. 5 depicts an illustrative environment for accessing a database using a self-learning JDBC driver according to embodiments.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As indicated herein, embodiments disclosed relate to database access. In particular, various embodiments relate to self-learned database access querying at a Java Database Connectivity (JDBC) driver.

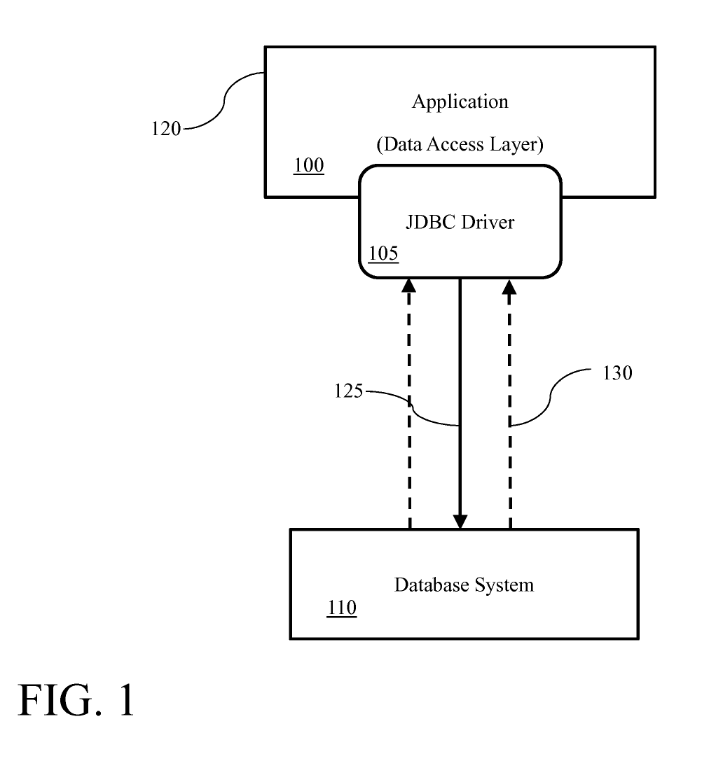

Referring to the schematic environment 120 in FIG. 1, a JDBC driver 105 is shown interposed between an application (or, program) 100 and a database system 110. The JDBC driver 105 is a software component that enables interaction between a Java application (e.g., application 100) and the database system 110. The JDBC driver 105 acts as a translator between the application 100 and the database system 110, converting requests from the application 100 to a protocol that the database system 110 can understand. The application 100 uses functions in the driver 105 to access data in the database system 110. The application 100 calls Java classes and interfaces to submit structured query language (SQL) statements and achieve results from the database system 110. When prompted by an application 100 (or program), the JDBC driver 105 communicates with the database system 110 through a computer subsystem, providing a pathway for transferring the query 125 and the result 130 between the application 100 and the database system 110. JDBC drivers 105 can use various strategies to “talk” to a database 110. JDBC drivers 105 are categorized according to the strategy used. Categories include JDBC-ODBC Bridge, Native API Driver, Network Protocol Driver (MiddleWare Driver), and Database Protocol Driver (Pure Java Driver). A JDBC-ODBC Bridge driver employs the open database connectivity (ODBC) driver to connect to the database. This driver converts JDBC method calls into ODBC function calls. A Native-API driver is a database driver that uses the client-side libraries of the database. The driver converts JDBC method calls into native calls of the database application programming interface (API). In contrast, a Network Protocol Driver for Database MiddleWare is a database driver implementation which uses a middle tier between the calling application and the database. The middle tier calls the JDBC driver 105, which converts the call made by the middleware directly or indirectly into a vendor-specific database protocol. Lastly, a Direct to Database Pure Java Driver is a database driver implementation that converts JDBC calls directly into a vendor-specific database protocol.

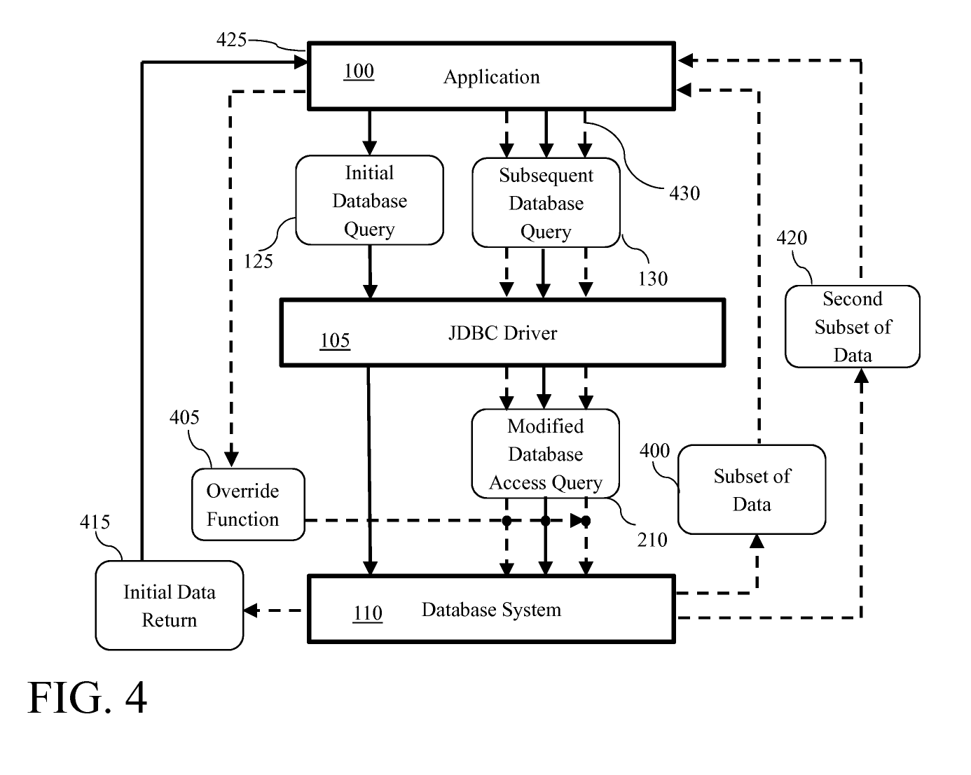

In practice, an initial query 125 requesting data from the database 110 is sent from the application 100 to the database system 110 through the JDBC driver 105. The JDBC driver 105 acts as an intermediary, transferring the database access query command from the application 100 to the database system 110. In return, the database system 110 sends a data return 415 (FIG. 4) to the application (or program) 100, which may be forwarded from the JDBC driver 105. A query may request one or more all fields attributable to one or more target data sets, such as personal identification, group identification, organization identification, etc. In some examples, fields can include: phone number, name, social security number, age, gender, organization name, domicile, location of incorporation, number of employees, etc. In addition, fields may be divided into subfields to narrow a classification. As used herein, the term “field” can refer to a data attribute corresponding with a target data set. For example, in the case that a target data set includes the identification of a person, a field in that target data set could include the phone number of the person, the name of the person, that person's social security number, etc. In various embodiments, at least two fields are required in order to accurately identify the target data set (e.g., the person). In the example of a business or corporate entity, the target data set can include fields such as state of incorporation, state of domicile, whether the entity is a corporation, a partnership, a non-profit organization, etc. A JDBC driver 105 can simplify programming by acting as a translator between a database system 110 and an application 100 which may allow for convenient transfer of fields of data.

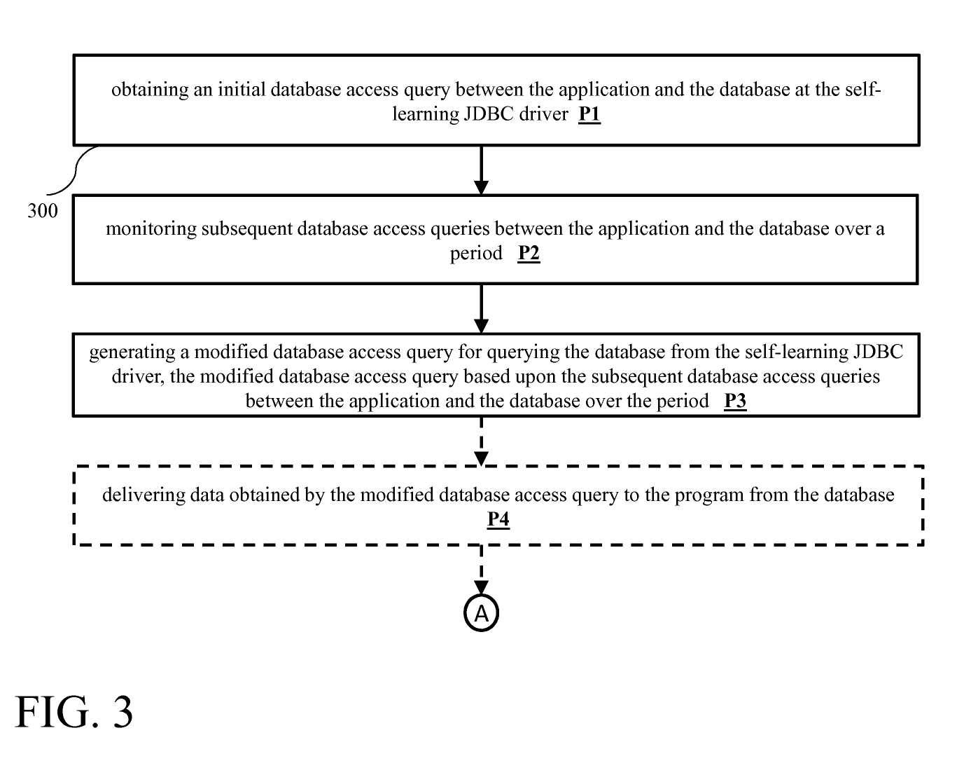

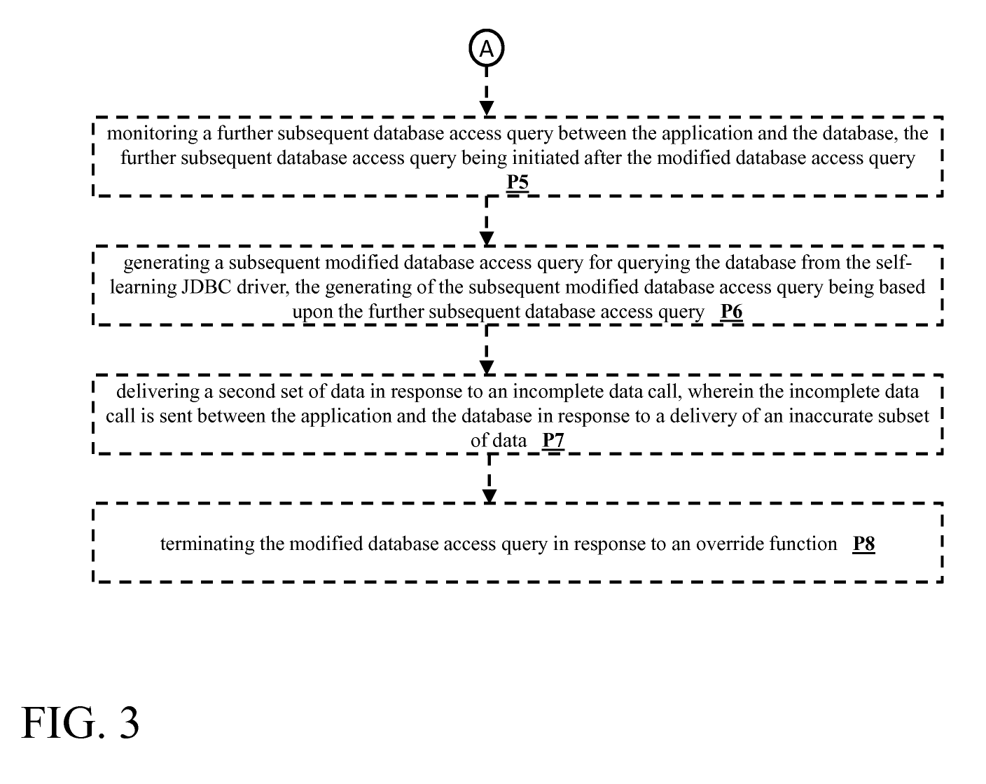

Referring to FIG. 3 with continuing reference to FIG. 1, a flow diagram is shown illustrating a method according to various embodiments. As shown, the method can include the following processes:

Process P1: Obtaining an initial database access query 125 between the application 100 and the database 110 at the self-learning JDBC driver 105. As previously discussed, the self-learning JDBC driver 105 is interposed between the application 100 and the database system 110. The self-learning JDBC driver 105 observes SQL statements (e.g., initial database query 125) sent from the application 100. The SQL statements include requests from the application to retrieve data from the database system 110.

Process P2: Monitoring subsequent database access queries 130 between the application 100 and the database 110 over a period. In an embodiment, the JDBC driver 105 is configured to actively learn from the database queries that it processes. That is, the JDBC driver 105 observes the results of the initial database query 125 and begins to aggregate the probability that the requested data is being utilized by the application 100. Based on the observation, the JDBC driver 105 can predict the data that will be used in subsequent database queries 130. It is understood that “period” may refer to, e.g., a time, a count, or any other division or subdivision of data collection.

Process P3: Generating a modified database access query 210 for querying the database 100 from the self-learning JDBC driver 105, the modified database access query 210 based upon the subsequent database access queries 130 between the application 100 and the database 110 over the period. The JDBC driver 105 uses the observations of initial database query results to create tailored, modified database access queries 210 at the JDBC driver 105 that target the data utilized from a prior data return. Upon a subsequent database access query 130 from an application 100, the JDBC driver 105 sends the modified database access query 210 instead of the subsequent database query 130. The process may be executed repeatedly until an override function is triggered. In another embodiment, the JDBC driver 105 is capable of sending multiple modified database access queries 210 in response to multiple unique subsequent database access queries 130.

Process P4: Delivering data obtained by the modified database access query 210 to the application 100 from the database 110. The modified database access query 210, retrieves a modified set of data consisting of a portion or a subset of data 400 from an initial database request data return 415 (See FIG. 4). This subset of data 400 can be delivered back to the application 100. Delivery may be through the JDBC driver 105.

Process P5: Monitoring a further subsequent database access query 430 between the application 100 and the database 110, the further subsequent database access query 430 being initiated after the modified database access query 210. In an embodiment, after a modified database query 210, the JDBC driver is capable of monitoring a further subsequent database access query 430. The method is similar to that of monitoring a subsequent database access query, wherein the JDBC driver 105 observes the results of the further subsequent database query 430 and begins to aggregate the probability that the requested data is being utilized by the consuming application 100.

Process P6: Generating a subsequent modified database access query 210 for querying the database 110 from the self-learning JDBC driver 105, the generating of the subsequent modified database access query 210 being based upon the further subsequent database access query 430. The JDBC driver 105 uses the observations of the subsequent modified database query results to create tailored, modified database access queries 210 at the JDBC driver 105 that target the data utilized from a prior data return. Upon a further subsequent database access query 430 from an application 100, the JDBC driver 105 sends the modified database access query 210 instead of the further subsequent database query 430. The process may be executed repeatedly until an override function is triggered.

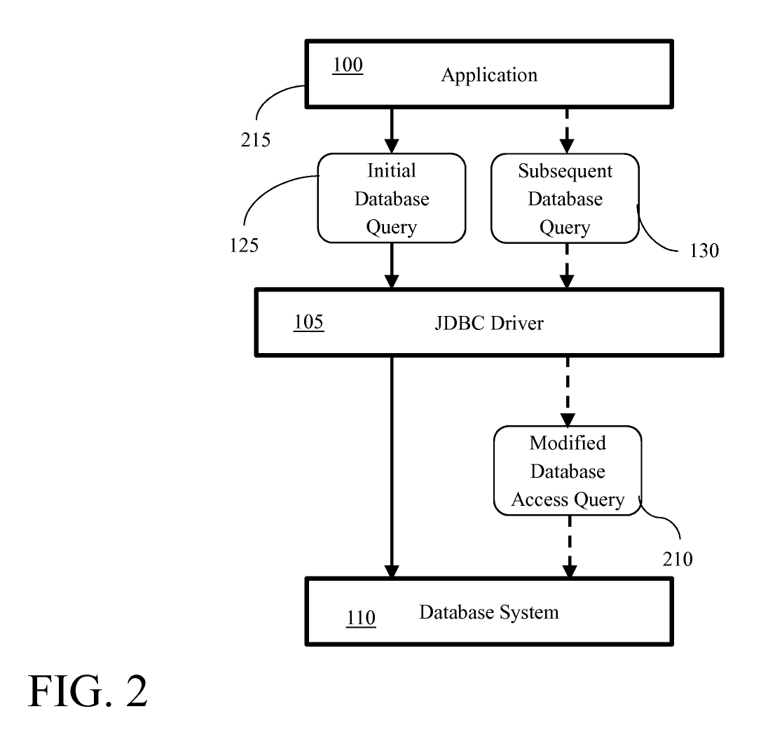

Process P7: Delivering a second set of data 420 in response to an incomplete data call, wherein the incomplete data call is sent between the application 100 and the database 110 in response to a delivery of an inaccurate subset of data. Another embodiment of the process includes sending a second set of data 420 in the event that a delivery of a subset of data 400 from a modified database access query 210 is inaccurate. The subset of data 400 may be inaccurate when it does not contain data required by the application 100. In response to a subsequent database access query 130, a modified database access query 210 is sent to the database 110, and a subset of data 400 is returned to the consuming application 100 as shown in FIG. 2. In the event that the consuming application 100 needs more or different data than what was returned in the subset of data 400, an incomplete data call is sent between the application 100 and the database 110. The incomplete data call prompts the database 110 to return either the full set of data from the initial query 125, a broader subset of data, including more data than the inaccurate subset of data, or a different subset of data, overriding the JDBC modified database access query 210.

Process P8: Terminating the modified database access query 210 in response to an override function 405 (See FIG. 4). As shown in one embodiment, the process includes an override function 405 for terminating the modified database access query 210. The override function 405 abandons the current modified database access query 210 and returns to the initial database access query 125 from the application (or program). The override function 405 may be user implemented, such as a command statement, or prompted by an inaccurate return of data from a modified database access query.

Turning to FIG. 4, a schematic data/process flow diagram 425 is shown to further illustrate the processes described with reference to the flow diagram 300 (FIG. 3). FIG. 4 is intended merely to illustrate some of the processes described herein, and should not be thought of as limiting the scope of those processes.

As demonstrated in FIG. 4, an embodiment of the process returns an initial data return 415 from the database system 110 in response to an initial database query 125 from the program (or application) 100. Upon subsequent database queries 130 requesting the same or similar data, the JDBC driver sends a modified database access query 210 to the database system 110. The modified database access query 210 requests a subset of data 400 from the initial database data return 415. The subset of data 400 may consist of only the data used by the consuming application from the original data set return, the data predicted likely to be used by the consuming application, the data historically used, data based on a usage rate, or any combination thereof.

For example, the consuming application may issue a SELECT statement on a 10 column table as follows: SELECT*FROM TESTABLE. From ResultSet that is issued, only two of the ten columns may be utilized by the consuming application. To avoid the unnecessary transfer of eight additional columns of data, one embodiment of the self-learning JDBC driver 105 may proactively inform the database system 110 to change the query from: SELECT*FROM TESTABLE to SELECT column1, column2 FROM TESTTABLE. As FIG. 4 shows, the JDBC driver 105 observes the initial database query 125. In varying embodiments, the initial query 125 need not necessarily come from a single application 100, but may come from one or more separate application(s) running on the same application server. In various embodiments, multiple applications (e.g., application(s) 100) on the same server use the same JDBC driver (e.g., JDBC driver 105). Each application 100 may have a distinct query from other application(s) or at least one application 100 can have a substantially identical query with at least one other application 100. Subsequent queries 130 between the application 100 and the database 110 are then modified according to the data utilized in the initial query. Other embodiments may include components in addition to the JDBC driver 105, the database system 110, and the application 100. For example, the present method may be utilized in a system with more than one application 100, database system 110, or interposed component. Another embodiment of the process herein disclosed provides that modified database access queries 210 can be based on trends in usage of subsets of data 400 returned in response to the modified database access queries 210 or initial database access queries 125. Such trends may include: frequency of use by the application 100 of a subset of data 400 from the initial access query 125, history of use of a subset of data 400 by the application 100 from the initial access query 125, or association between two separate database access queries 125 from the application 100. For example, in various embodiments, the application 100 sends a first query requesting all fields with social security numbers, and a second query requesting all fields with the family name “Smith”. The second query may cause confusion and return too much data (e.g., as “Smith” is a common name). The JDBC driver 105 may note the association between the subsets of data 400 used from the first and second fields of data (e.g., every time “John Smith” is used by the application 100, the social security number “111-11-1111” is also used). This trend allows the JDBC driver 105 to learn which types of data are associated in the initial data returns 415.

In various embodiments described herein, the terms “application” or “program”, may include, for example, Java applications using JDBC drivers 105 to connect to back end data bases, applications using Java persistence Architecture (JPA) and/or any Object Relation Mapping (ORM) framework. Further, the terms “database” or “database structure”, or “database system” as used in this disclosure, may include: federated databases, non-SQL databases, relational databases and/or master data management (MDM) databases. “Query”, “database access query”, and all variations thereof as described herein may include: select, insert results, insert values, update, delete, and/or joins.

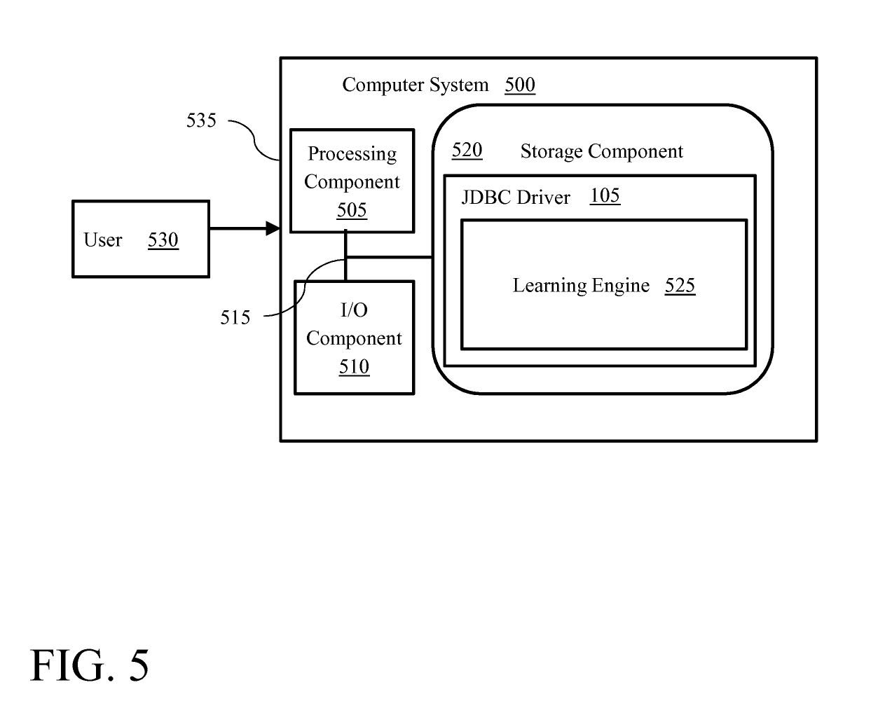

FIG. 5 depicts an illustrative environment 535 for database access via a self-learning JDBC driver 105 according to an embodiment. To this extent, the environment 535 includes a computer system 500 that can perform a process described herein in order to proactively modify a subsequent database access query. In particular, the computer system 500 is shown as including a JDBC driver 105 having a learning engine 525, which makes computer system 500 operable to proactively create modified database access queries 210 by performing any/all of the processes described herein and implementing any/all of the embodiments described herein.

The computer system 500 is shown including a processing component 505 (e.g., one or more processors), a storage component 520 (e.g., a storage hierarchy), an input/output (I/O) component 510 (e.g., one or more I/O interfaces and/or devices), and a communications pathway 515. In general, the processing component 505 executes program code, such as the JDBC Driver 105, which is at least partially fixed in the storage component 520. While executing program code, the processing component 505 can process data, which can result in reading and/or writing transformed data from/to the storage component 520 and/or the I/O component 510 for further processing. The pathway 515 provides a communications link between each of the components in the computer system 500. The I/O component 510 can comprise one or more human I/O devices, which enable a human user 530 to interact with the computer system 500 and/or one or more communications devices to enable a system user 530 to communicate with the computer system 500 using any type of communications link.

The computer system 500 can comprise one or more general purpose computing articles of manufacture (e.g., computing devices) capable of executing program code, such as the JDBC driver 105, having a learning engine 525, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, JDBC driver 105 can be embodied as any combination of system software and/or application software.

Further, the self-learning JDBC driver 105 can be implemented using a set of modules. In this case, a module can enable the computer system 500 to perform a set of tasks used by the self-learning JDBC driver 105, and can be separately developed and/or implemented apart from other portions of the self-learning JDBC driver 105. As used herein, the term “component” means any configuration of hardware, with or without software, which implements the functionality described in conjunction therewith using any solution, while the term “module” means program code that enables the computer system 500 to implement the functionality described in conjunction therewith using any solution. When fixed in a storage component 520 of a computer system 500 that includes a processing component 505, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 500.

When the computer system 500 comprises multiple computing devices, each computing device may have only a portion of the JDBC driver fixed thereon (e.g., one or more modules). However, it is understood that the computer system 500 and JDBC driver 105 are only representative of various possible equivalent computer systems that may perform a process described herein. To this extent, in other embodiments, the functionality provided by the computer system 500 and JDBC driver 105, having a learning engine 525, can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 500 includes multiple computing devices, the computing devices can communicate over any type of communications link. Further, while performing a process described herein, the computer system 500 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 500 can obtain or provide data, such as database access queries (e.g., initial database access query 125) and/or data returns (e.g., initial data return 415) using any solution. For example, the computer system 500 can generate and/or be used to generate database queries from one or more data stores, receive return data from another system, and/or send data to another system.

While shown and described herein as self-learning JDBC driver 105, it is understood that aspects of the invention further provide various alternative embodiments. For example, in one embodiment, the invention provides a computer program fixed in at least one computer-readable medium, which when executed, enables a computer system to manage a Java Database Connectivity (JDBC) driver data query at a self-learning JDBC driver 105 interposed between an application 100 and a database 110. To this extent, the computer-readable medium includes program code, such as the JDBC driver 105, having a learning engine 525 (FIG. 5), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the JDBC driver 105, having a learning engine 525 (FIG. 5), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In various embodiments of the invention, the self-learning JDBC driver queries data that is static in nature and does not dynamically change the data that it is accessing. However, other embodiments may include accessing databases that are not static in nature. In an embodiment, the JDBC driver 105 replaces a modified database access query 210 with a new modified query in response to the addition of data to the database 110. For example, if a new column or table is added to the database system 110 after a modified database access query 210, the JDBC driver 105 can learn of this new addition and undo the previously modified database access query 210. This enables the JDBC driver 105 to re-learn the new pattern of data access by the application 100 based upon the updated query. The user may be able to select a setting for their JDBC connection to specify that the application should take advantage of the self-learning JDBC driver 105 in a static or non-static data transfer.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

We claim:

1. A computer-implemented method of managing a Java Database Connectivity (JDBC) driver data query at a self-learning JDBC driver interposed between an application and a database, the method comprising:
obtaining an initial database access query between the application and the database at the self-learning JDBC driver;
monitoring subsequent database access queries between the application and the database over a period; and
generating a modified database access query for querying the database from the self-learning JDBC driver, the modified database access query based upon the subsequent database access queries between the application and the database over the period.

2. The computer-implemented method of claim 1, further comprising delivering data obtained by the modified database access query to the application from the database.

3. The computer-implemented method of claim 1, further comprising:
monitoring a further subsequent database access query between the application and the database, the further subsequent database access query being initiated after the modified database access query; and
generating a subsequent modified database access query for querying the database from the self-learning JDBC driver, the generating of the subsequent modified database access query being based upon the further subsequent database access query.

4. The computer-implemented method of claim 1, further comprising terminating the modified database access query in response to an override function.

5. The computer-implemented method of claim 1, wherein the modified access query retrieves a subset of data requested in the initial access query.

6. The computer-implemented method of claim 5, further comprising delivering a second set of data in response to an incomplete data call, wherein the incomplete data call is sent between the application and the database in response to a delivery of an inaccurate subset of data.

7. The computer-implemented method of claim 1, wherein the application includes at least one of: a Java application using a JDBC driver to connect to a back end database, an application using Java persistence Architecture (JPA), or any Object Relation Mapping (ORM) framework, the database includes at least one of: a federated database, a non-SQL database, a relational database, or a master data management (MDM) database, and the query includes at least one of: select, insert results, insert values, update, delete, or join.

8. The computer-implemented method of claim 1, wherein the subsequent database access queries include requests by the application, for data from the database, wherein the requests by the application for data from the database include requests for subsets of data included in the initial database access query, wherein the generating of the modified database access query includes determining a trend across the subset of data and generating the subsequent database access query based upon the trend.

9. The computer-implemented method of claim 8, wherein the trend includes at least one of frequency of use by the application of a subset of data from the initial access query, history of use of a subset of data by the application from the initial access query, or association between two separate database access queries from the application.

10. A system comprising:
at least one computing device associated with a Java Database Connectivity (JDBC) driver interposed between an application and a database, the at least one computing device configured to manage a data query at the self-learning JDBC driver by performing actions including:
obtaining an initial database access query between the application and the database at the self-learning JDBC driver;
monitoring subsequent database access queries between the application and the database over a period; and
generating a modified database access query for querying the database from the self-learning JDBC driver, the modified database access query based upon the subsequent database access queries between the application and the database over the period.

11. The system of claim 10, wherein the at least one computing device is further configured to perform:
monitoring a further subsequent database access query between the application and the database, the further subsequent database access query being initiated after the modified database access query; and
generating a subsequent modified database access query for querying the database from the self-learning JDBC driver, the generating of the subsequent modified database access query being based upon the further subsequent database access query.

12. The system of claim 10, wherein the at least one computing device is further configured to deliver a second set of data in response to an incomplete data call, wherein the incomplete data call is sent between the application and the database in response to a delivery of an inaccurate subset of data.

13. The system of claim 10, wherein the application includes at least one of: a Java application using a JDBC driver to connect to a back end database, an application using Java persistence Architecture (JPA), or any Object Relation Mapping (ORM) framework, the database includes at least one of: a federated database, a non-SQL database, a relational database, or a master data management (MDM) database, and the query includes at least one of: select, insert results, insert values, update, delete, or join.

14. The system of claim 10, wherein the subsequent database access queries include requests by the application for data from the database, wherein the requests by the application for data from the database include requests for subsets of data included in the initial database access query, wherein the generating of the modified database access query includes determining a trend across the subset of data and generating the subsequent database access query based upon the trend.

15. The system of claim 14, wherein the trend includes at least one of frequency of use by the application of a subset of data from the initial access query, history of use of a subset of data by the application from the initial access query, or association between two separate database access queries from the application.

16. A computer program comprising program code embodied in at least one computer-readable storage medium, which when executed, enables a computer system interposed between an application and a database to manage a Java Database Connectivity (JDBC) driver data query by performing actions including:
obtaining an initial database access query between the application and the database at the self-learning JDBC driver;
monitoring subsequent database access queries between the application and the database over a period; and
generating a modified database access query for querying the database from the self-learning JDBC driver, the modified database access query based upon the subsequent database access queries between the application and the database over the period.

17. The computer program of claim 16, further comprising:
monitoring a further subsequent database access query between the application and the database, the further subsequent database access query being initiated after the modified database access query; and
generating a subsequent modified database access query for querying the database from the self-learning JDBC driver, the generating of the subsequent modified database access query being based upon the further subsequent database access query.

18. The computer program of claim 16, further comprising delivering a second set of data in response to an incomplete data call, wherein the incomplete data call is sent between the application and the database in response to a delivery of an inaccurate subset of data.

19. The computer program of claim 16, wherein the application includes at least one of: a Java application using a JDBC driver to connect to a back end database, an application using Java persistence Architecture (JPA), or any Object Relation Mapping (ORM) framework, the database includes at least one of: a federated database, a non-SQL database, a relational database, or a master data management (MDM) database, and the query includes at least one of: select, insert results, insert values, update, delete, or join.

20. The computer program of claim 16, wherein the subsequent database access queries include requests by the application, for data from the database, wherein the requests by the application for data from the database include requests for subsets of data included in the initial database access query, wherein the generating of the modified database access query includes determining a trend across the subset of data and generating the subsequent database access query based upon the trend.
